(19) United States
(12) Patent Application Publication
(10) Pub. No.: US 2025/0343369 A1
(43) Pub. Date: Nov. 6, 2025

(54) CONNECTOR, CONNECTOR PAIR, AND METHOD OF MANUFACTURING CONNECTOR

(71) Applicant: Molex, LLC, Lisle, IL (US)

(72) Inventors: Toshiyuki Someya, Yamato (JP); Koichi Tanimura, Yamato (JP); Hironobu Murakami, Yamato (JP)

(21) Appl. No.: 18/855,325

(22) PCT Filed: Jun. 23, 2023
(86) PCT No.: PCT/IB2023/056527

§ 371 Date: Oct. 9, 2024

(30) Foreign Application Priority Data
Jun. 23, 2022 (JP) 2022-100903

(51) Int. Cl. H01R 12/71; H01R 43/24

(52) U.S. Cl. CPC H01R 12/716; H01R 43/24

(57) ABSTRACT

A connector, comprising: a connector main body. and a plurality of terminals attached to the connector main body; wherein the plurality of terminals form a terminal row extending in the longitudinal direction of the connector, a first terminal of a pair of adjacent terminals has an end surface facing outward in the width direction of the connector and a lower surface adjacent to this end surface, the lower surface for soldering to a board, and a second terminal of the pair of adjacent terminals has an end surface facing outward in the width direction of the connector, the end surface being positioned higher than the lower surface of the first terminal.

### CROSS-REFERENCE TO RELATED APPLICATIONS

This international PCT patent application claims the benefit of priority to Japanese Patent Application No. 2022-100903, filed on Jun. 23, 2022. The above-referenced patent application is herein incorporated by reference in its entirety.

### TECHNICAL FIELD

The present disclosure relates to a connector, a connector pair, and a method of manufacturing thereof.

### BACKGROUND ART

Conventionally, connectors such as board-to-board connectors have been used to electrically connect pairs of parallel circuit boards to each other. These types of connectors are attached to both opposing surfaces of a pair of circuit boards and fitted together to ensure electric conduction (for example, see Patent Reference 1).

FIG. 17 is a cross section view depicting a conventional connector.

In the figure, 801 represents a first connector as a connector mounted on a surface of a first circuit board and 901 represents a second connector as a connector mounted on a surface of a second circuit board (not depicted). The first connector 801 and second connector 901, as indicated in the drawings, are moved from a mutually facing orientation in a direction of mutual approaching, and then are mated together.

The second connector 901 includes a second housing 911 and a plurality of second terminals 961 arranged in two rows on the left and right mounted in the second housing 911. The second terminals 961 of the right row and the second terminals 961 of the left row have the same shape and face each other. Furthermore, a board connecting part 962 of each of the second terminals 961 protrudes outward in the width direction of the second housing 911.

On the other hand, the first connector 801 includes a first housing 811 and a first terminal row 860A and second terminal row 860B arranged along the two long sides on the left and right of the first housing 811. Furthermore, in both the first terminal row 860A and the second terminal row 860B, type a first terminals 861a and type b first terminals 861b are alternately arranged. In addition, the type a first terminals 861a and the type b first terminals 861b are arranged so as to line up in the width direction.

A board connecting part 862a of the type a first terminals 861a protrudes outward in the width direction of the first housing 811. On the other hand, a board connecting part 862b of the type b first terminals 861b protrudes inward in the width direction of the first housing 811 and the length thereof is set shorter than the board connecting part 862a of the type a first terminals 861a. Furthermore, the board connecting part 862b of the type b first terminals 861b are exposed in a window 813 formed in an inner portion in the width direction of the first housing 811 and are mounted on a surface of the second circuit board.

In this manner, in the first connector 801 that is smaller than the second connector 901, the type a first terminals 861a and type b first terminals 861b are alternately arranged, so that in the longitudinal direction, the board connecting part 862a and board connecting part 862b are arranged in a staggered pattern, enlarging the mutual spacing thereof such that solder bridging does not occur, soldering work can easily be achieved, and favorable electrical characteristics can be ensured.

Prior Art Documents: Patent Documents: Patent Document 1: Japanese Unexamined Patent Application 2016-152083.

### SUMMARY

However, in the conventional connector, the type a first terminals 861a and type b first terminals 861b are formed integrated with the first housing 811 so if size is reduced, spacing between the first terminal row 860A and the second terminal row 860B is narrowed and the pitch of the type a first terminals 861a and type b first terminals 861b of the first terminal row 860A and the second terminal row 860B is narrowed, causing manufacturing to become difficult.

Normally, in a connector, terminals are integrated with a protruding part of the housing using a molding method called over-molding or insert molding so the spacing between portions where respective terminal rows are formed is narrowed and the pitch of terminals in each terminal row is narrowed so accurately arranging the plurality of terminals in positions corresponding to the pair of protruding parts in the die for molding the housing becomes difficult.

Here, an object is to provide a connector, connector pair, and method for manufacturing that resolves the conventional problems enabling narrowing the pitch between terminals in a terminal row and narrowing the spacing between terminal rows, where solder bridging does not occur, manufacturing is simple, size reduction is feasible even with multiple poles, and reliability is high.

Therefore, a connector, includes:
a connector main body, and a plurality of terminals attached to the connector main body; wherein
the plurality of terminals form a terminal row extending in the longitudinal direction of the connector,
a first terminal of a pair of adjacent terminals has an end surface facing outward in the width direction of the connector and a lower surface adjacent to this end surface, the lower surface for soldering to a board, and
a second terminal of the pair of adjacent terminals has an end surface facing outward in the width direction of the connector, the end surface being positioned higher than the lower surface of the first terminal.

In another connector,
the terminals have a board connecting part,
there are a plurality of terminal rows, and of the end surfaces of the board connecting parts, end surfaces that face an adjacent terminal row are plated and end surfaces that do not face the adjacent terminal row are not plated.

In yet another connector, the terminals are integrally retained in the connector main body and the plurality of terminal rows are integrally linked.

In yet another connector, the outer surface positions of adjacent terminals in the terminal row are mutually shifted in the width direction of the connector.

In yet another connector, the terminals have two contact surfaces and the positions of the contact surfaces of two adjacent terminals in the terminal row are mutually shifted in the width direction of the connector.

In yet another connector, the terminals have a board connecting part and of the two contact surfaces, the width dimension of the contact surface on the proximal side of the board connecting part is larger than that of the contact surface on the distal side of the board connecting part.

A connector pair includes a connector according to the present disclosure and a mating connector that mates with the connector.

A method of manufacturing a connector having a connector main body provided with a plurality of terminals attached to the connector main body, the connectors forming a terminal row extending in the longitudinal direction of the connector, includes:
a step of integrally molding terminals that are adjacent in a terminal row and are connected by overlapping and mutually different carriers;
a step of integrally molding with the connector main body: a first of the adjacent terminals having a board connecting part connected to a first of the mutually different carriers, and a second of the adjacent terminals having a non-board connecting part connected to a second of the mutually different carriers and the first carrier overlaps below the second carrier; and a step of separating the terminals integrally molded with the connector main body from the carrier.

The present disclosure enables narrowing the pitch between terminals in a terminal row, narrowing the spacing between terminal rows, preventing occurrence of solder bridging, simplifying manufacturing, size reduction even when there are multiple poles, and improving reliability.

### BRIEF DESCRIPTION OF THE DRAWINGS

FIG. 1 is a perspective view of a first connector according to the present embodiment:

FIG. 2 is an exploded view of the first connector according to the present embodiment:

FIG. 3 is a three-plane diagram of a first connector according to the present embodiment, where FIG. 3A is a top view, FIG. 3B is a side view, and FIG. 3C is a bottom view;

FIG. 4 is a side view of the first connector according to the present embodiment, where FIG. 4A is an overall view, and FIG. 4B is an exploded view of the B part of FIG. 4A;

FIG. 5 is an enlarged view of a main part of the first connector in the present embodiment, and is an enlarged view of the A part in FIG. 1;

FIG. 6 is a perspective view depicting a first process to produce the first connector according to the present embodiment;

FIG. 7 is a perspective view depicting a first carrier to which a first terminal of the present embodiment is connected, where FIG. 7A is a diagram depicting a carrier connected to the first terminal corresponding to a first terminal row, and FIG. 7B is a diagram depicting a carrier connected to the first terminal corresponding to a second terminal row;

FIG. 8 is a perspective view depicting a second carrier to which a first terminal of the present embodiment is connected, where FIG. 8A is a diagram depicting a carrier connected to the first terminal corresponding to a first terminal row, and FIG. 8B is a diagram depicting a carrier connected to the first terminal corresponding to a second terminal row;

FIG. 9 is a perspective view depicting a second process to produce the first connector according to the present embodiment:

FIG. 10 is a perspective view of a second connector according to the present embodiment;

FIG. 11 is an exploded view of the second connector according to the present embodiment;

FIG. 12 is a first two-plane diagram of the second connector according to the present embodiment, where FIG. 12A is a top view, and FIG. 12B is a bottom view;

FIG. 13 is a second two-plane diagram of the second connector according to the present embodiment, where FIG. 13A is a side view, and FIG. 13B is a front view;

FIG. 14 is a perspective view viewed from the first connector side depicting the state of the first connector and the second connector mated according to the present embodiment;

FIG. 15 is a plan view viewed from the first connector side depicting the state of the first connector and the second connector in a mated state according to the present embodiment;

FIG. 16 is a cross-sectional view with the first connector and second connector of the present embodiment in a mated state where FIG. 16A is a cross section view taken along the line L-L in FIG. 15, and FIG. 16B is a cross section view taken along the line M-M in FIG. 15; and

FIG. 17 is a cross section view depicting a conventional connector.

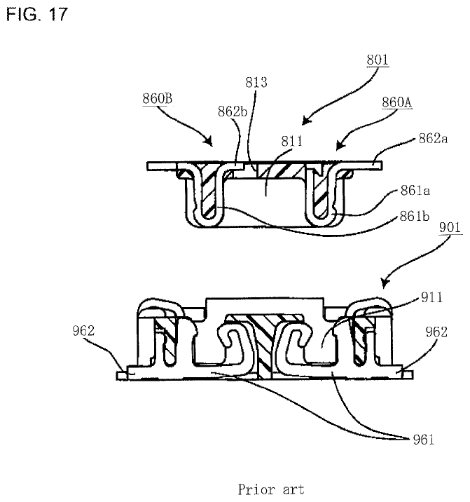

### DETAILED DESCRIPTION OF THE PREFERRED EMBODIMENTS

Embodiments will hereinafter be described in detail with reference to the drawings.

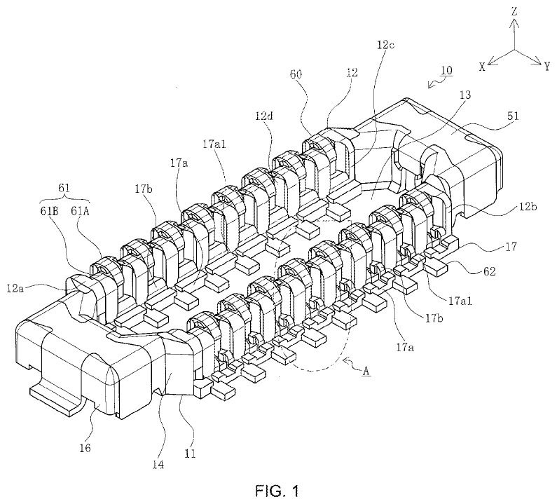

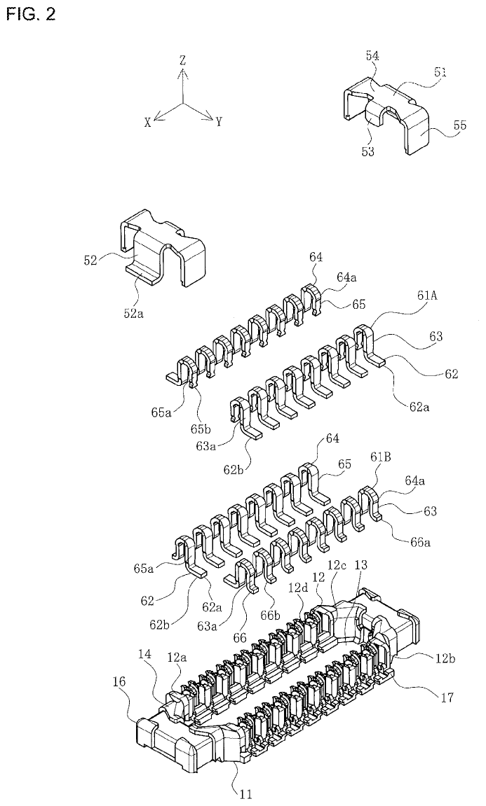

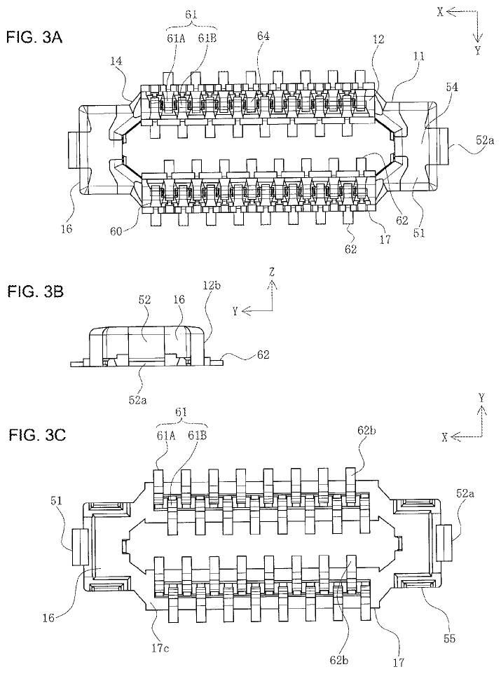

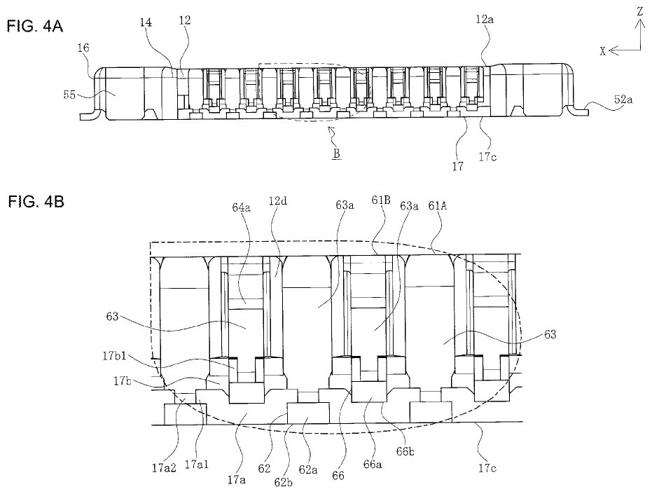

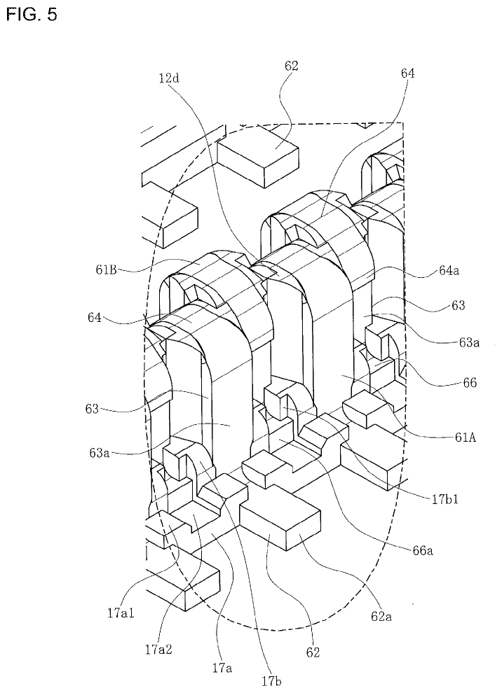

FIG. 1 is a perspective view of the first connector according to the present embodiment. FIG. 2 is an exploded view of the first connector according to the present embodiment. FIG. 3 is a three-plane view of the first connector according to the present embodiment. FIG. 4 is a side view of the first connector according to the present embodiment. FIG. 5 is an enlarged view of a main part of the first connector in the present embodiment, and is an enlarged view of the A part in FIG. 1. Note that in FIG. 3, (a) is a top view, (b) is a front view, and (c) is a bottom view. In FIG. 4, (a) is an overall view, and (b) is an enlarged view of the B part in (a).

In the diagrams, 10 is a first connector as a first of a pair of board-to-board connectors that are connectors of the present embodiment. The first connector 10 is a surface mounting type connector mounted on the surface of a first board (not depicted) serving as a mounting member and is mated to a second connector 101 (described below) that serves as a counterpart connector. Furthermore, the second connector 101 is the other of the pair of board-to-board connectors and is a surface mount type connector mounted on the surface of a second board (not depicted) serving as a mounting member.

The first connector 10 and the second connector 101 according to the present embodiment are preferably used to electrically connect the first board to the second board, but can also be used to electrically connect other members. For example, the first board and the second board are each a printed circuit board, a flexible flat cable (FFC), a flexible circuit board (FPC), or the like as used in electronic devices or the like, but may be any type of board.

In addition, in the present embodiment, expressions indicating direction such as top, bottom, left, right, front, rear, and the like used to describe the configuration and operation of each part of the first connector 10 and the second connector 101 are relative rather than absolute and are appropriate when each part of the first connector 10 and the second connector 101 are in the positions depicted in the drawings; and these directions should be interpreted as changing in accordance with the change in position when the position thereof is changed.

The first connector 10 is integrally formed by an insulating material such as synthetic resin and includes a first housing 11 as a connector main body having a substantially flattened square shape in plan view. The first housing 11 includes a pair of protruding parts 12 extending in the longitudinal direction (X-axis direction) of the first connector 10 and a pair of first protruding end parts 16 connected to and coupled with both ends of the protruding parts 12 in the longitudinal direction. Note that the pair of protruding parts 12 face each other and are mutually parallel, and function as terminal retention parts for retaining the first terminals 61. In addition, the pair of first protruding end parts 16 face each other and are mutually parallel. Both ends of the protruding parts 12 in the longitudinal direction are connected to a first protruding end part 16 via an extension end part 14 extending in a direction inclined relative to the longitudinal direction (X-axis direction) of the first connector 10. In addition, a space demarcated by the pair of protruding parts 12, pair of first protruding end parts 16, and the extension end parts 14 is a long, narrow recessed groove part 13 extending in the longitudinal direction of the first connector 10. The recessed groove part 13 is a through-hole that is open on the upper surface and the lower surface of the first connector 10.

Note that in the present embodiment, the recessed groove part 13 is described as one through-hole; but may be a hole with a bottom having a bottom plate. In addition, the bottom plate may have a plurality of through-holes and in this case, the through-holes are desirably set to enable visually confirming a tail part 62 of the first terminals 61 positioned in the recessed groove part 13. Thus, the appearance and the like of the connected state of the tail part 62 and the board by means of soldering or the like can easily be confirmed from the outside.

Furthermore, in the present embodiment, for convenience of description, the first connector 10 is described as having a pair of protruding parts 12, that is, a configuration in which two of the protruding parts are arranged in parallel; however, three or more of the protruding parts 12 may be arranged in parallel. In addition, the first housing 11 does not necessarily have to have a substantially square shape and may have any shape so long as the longitudinal direction ends can be connected by the first protruding end parts 16.

The first housing 11 is integrally formed with the first terminals 61 as terminals and first reinforcement fitting 51 as a reinforcement fitting using a molding method called over-molding, outsert molding, or insert molding (hereinafter, called “insert molding”). In other words, the first housing 11 is molded by filling the cavity of a mold, in which the first terminals 61 and first reinforcement fitting 51 have been set beforehand, with an insulating material. Therefore, the first terminals 61 and first reinforcement fitting 51 do not exist separated from the first housing 11, in other words, the shape depicted in FIG. 2 with the location of the first terminals 61 and the first reinforcement fitting 51 mounted on the first housing 11 in a state of the first terminals 61 and first reinforcement fitting 51 being separated does not exist. It should be noted that the depiction in FIG. 2 is only for convenience of explanation.

In the present embodiment, there are a plurality of first terminals 61 that form a plurality of terminal rows 60 that are rows extending in the longitudinal direction of the first connector 10 and are attached to the protruding parts 12. In the first housing 11, a plurality of protruding parts 12 are integrally connected to the first protruding end parts 16 so the plurality of terminal rows 60 are also retained on the protruding parts 12 of the first housing 11 and can be said to be integrally connected.

In addition, the first terminals 61 include a first type of terminal first terminals 61A and a second type of terminal first terminals 61B. Furthermore, in each terminal row 60, the first terminals 61A and the first terminals 61B are arranged alternately. In addition, a first terminal row 60 and a second terminal row 60 are arranged so that the first terminals 61A and the first terminals 61B are lined up in the width direction (Y-axis direction) of the first connector 10. Note that in the example depicted in the drawings, eight each of the first terminals 61A and the first terminals 61B are arranged at a prescribed pitch (for example, approximately 0.18 [mm]) in each of the terminal rows 60 but the number and pitch of the first terminals 61 in each of the terminal rows 60 can be changed as appropriate.

The protruding part 12 includes a mating surface 12a that is the upper surface facing upward (Z-axis positive direction) and an outer surface 12b and inner surface 12c connected to both left and right sides of this mating surface 12a. The outer surface 12b is a surface facing outward in the width direction of the first housing 11 and the inner surface 12c is a surface facing inward, toward the recessed groove part 13, in the width direction of the first housing 11. In addition, the protruding part 12 includes an inter-terminal wall 12d interposed between mutually adjacent first terminals 61 in the terminal rows 60, in other words, between the first terminals 61A and the first terminals 61B that are mutually adjacent. The inter-terminal wall 12d is a portion that maintains insulation between mutually adjacent first terminals 61 in the terminal rows 60.

In addition, a bottom plate part 17 is formed at the bottom end of the protruding part 12. Furthermore, the bottom plate part 17 is positioned at the bottom, protrudes to the outside of the outer surface 12b in the width direction of the first housing 11, and includes a plate shaped lower plate part 17a that protrudes to the inside of the inner surface 12c in the width direction of the first housing 11 and a plate shaped upper plate part 17b that is positioned above the lower plate part 17a, in which both ends thereof, in the width direction of the first housing 11, are approximately in the same positions as the outer surface 12b and inner surface 12c. In addition, a lower surface 17c of the bottom plate part 17 is a mounting surface of the first housing 11 facing the surface of the first board.

The first terminal 61 is a member integrally formed by carrying out processing such as punching and bending on a conductive metal plate. Furthermore, the first terminals 61A that are a first type of terminal include an outer column part 63 that extends in the vertical direction (Z-axis direction), a tail part 62 that protrudes outwardly in the width direction of the first housing 11 from the bottom end of the outer column part 63 as a board connecting part, an inner column part 65 that extends vertically opposite the outer column part 63, and a connecting part 64 that is curved and connects the upper end of the inner column part 65 and the upper end of the outer column part 63. The outer surface of the outer column part 63 in the width direction of the first housing 11 is an outer surface 63a that functions as a contact surface for contacting with second terminals 161 of a second connector 101, described below. The inner surface of the inner column part 65 in the width direction of the first housing 11 is an inner surface 65a that functions as a contact surface that contacts with the second terminals 161 of the second connector 101, described below. In addition, an anchor part 65b having an anchor shape is formed on the lower end of the inner column part 65 and is embedded in the bottom plate part 17 of the first housing 11 to prevent detachment. Furthermore, an upper end protruding part 64a that protrudes toward the inside of the first housing 11 in the width direction is formed at the boundary of the upper end of the inner column part 65 and the connecting part 64. Furthermore, an end surface 62a at the tip of the tail part 62 is a cross section produced by separation from a connecting arm 68a of a terminal carrier 68, described below. Furthermore, the lower surface 62b of the tail part 62 is adjacent to the end surface 62a and connected to the conductive trace of the first board and is a connecting surface that is connected, by means of soldering or the like, to a connection pad formed on a surface of the first board. Note that the conductive trace is typically a signal line but also may be a power line.

In addition, the first terminals 61B that are a second type of terminal include an outer column part 63 extending in the vertical direction (Z-axis direction), a horizontal part 66 protruding slightly outward from the bottom end of the outer column part 63 in the width direction of the first housing 11, an inner column part 65 opposite the outer column part 63 and extending in the vertical direction, and a connecting part 64 that is curved and connects the upper end of the inner column part 65 and the upper end of the outer column part 63. Furthermore, the tail part 62 protruding inward in the width direction of the first housing 11 is connected to the lower end of the inner column part 65 as a board connecting part.

Note that the horizontal part 66 has a shape similar to that of the tail part 62 but is a portion formed shorter than the tail part 62 and is a member that does not function as a board connecting part. In other words, the horizontal part 66 can be said to be a non-tail part that is a non-board connecting part. In addition, the horizontal part 66 is embedded in the bottom plate part 17 of the first housing 11 and exhibits a function as an anchor to prevent coming off to a certain degree.

In addition, the outer surface of the outer column part 63 in the width direction of the first housing 11 is an outer surface 63a that functions as a contact surface for contacting with second terminals 161 of a second connector 101, described below. The inner surface of the inner column part 65 in the width direction of the first housing 11 is an inner surface 65a that functions as a contact surface that contacts with the second terminals 161 of the second connector 101, described below.

Furthermore, an upper end protruding part 64a that protrudes toward the outside of the first housing 11 in the width direction is formed at the boundary of the upper end of the outer column part 63 and the connecting part 64. Furthermore, an end surface 66a at the tip of the horizontal part 66 is a cross section produced by separation from a connecting arm 68a of a terminal carrier 68, described below. Furthermore, the lower surface 62b of the tail part 62 is connected to the conductive trace of the first board and is a connecting surface that is connected, by means of soldering or the like, to a connection pad formed on a surface of the first board. Note that the conductive trace is typically a signal line but also may be a power line.

Note that for the first terminals 61A, the width dimension of the outer surface 63a (dimension in the X-axis direction) is larger than the inner surface 65a and for the first terminals 61B, the width dimension of the inner surface 65a is larger than the outer surface 63a. In other words, for the first terminals 61, the width dimension of the contact surface on the proximal side of the tail part 62 is larger than the contact surface on the distal side of the tail part 62.

As described above, in each of the terminal rows 60, the first terminals 61A and first terminals 61B are alternately arranged, or a first terminal row 60 and an adjacent terminal row 60 are arranged so the first terminals 61A and first terminals 61B are lined up with regards to the width direction (Y-axis direction) of the first connector 10. Therefore, in the example depicted in FIG. 3(a), the orientation of the first terminals 61A that, of the terminal row 60 positioned on the bottom side, are the first terminals 61 positioned on the front end (X-axis positive direction end) is in the direction of the tail part 62 protruding toward the outside (Y-axis positive direction side); while the orientation of the first terminals 61B that are the first terminals 61 positioned second from the front end is in the direction of the tail part 62 protruding toward the inside (Y-axis negative direction side). In this manner, as the first terminals 61 are mounted on the protruding part 12 arranged in a line in mutually opposing directions, the pitch of the tail parts 62 protruding from both sides of the protruding part 12 is twice that of the pitch of the first terminal 61. This configuration facilitates the operation of connecting the first terminal to the connection pad of the first board by soldering or the like.

Furthermore, with the first terminals 61 in a state of being integrated with the first housing 11, the upper surface of the connecting part 64 is positioned roughly the same as the mating surface 12a that is the upper surface of the protruding part 12. In other words, the upper surface of the connecting part 64 of each of the first terminals 61 is substantially flush with the mating surface 12a of the protruding parts 12. In addition, the outer surfaces 63a of the first terminals 61A are at substantially the same position as the outer surface 12b of the protruding part 12. In other words, the outer surface 63a of each of the first terminals 61A is substantially flush with the outer surface 12b of the protruding parts 12. Conversely, the outer surfaces 63a of the first terminals 61B are positioned more to the inside of the first housing 11 in the width direction than the outer surfaces 63a of the first terminals 61A and the outer surfaces 12b of the protruding parts 12. In other words, the outer surfaces 63a of the first terminals 61B are shifted more inward in the width direction of the first housing 11 than the outer surfaces 63a of the first terminals 61A and the outer surfaces 12b of the protruding parts 12. Note that the end surface 66a of the tip of the horizontal part 66 of the first terminals 61B is substantially at the same position as the outer surface 63a of the first terminals 61A and the outer surface 12b of the protruding parts 12.

In addition, the inner surface 65a of the first terminals 61B is substantially at the same position as the inner surface 12c of the protruding parts 12. In other words, the inner surface 65a of each of the first terminals 61B is substantially flush with the inner surface 12c of the protruding parts 12. Conversely, the inner surface 65a of the first terminals 61A is positioned more to the outside in the width direction of the first housing 11 than the inner surface 65a of the first terminals 61B and the inner surface 12c of the protruding parts 12. In other words, the inner surface 65a of the first terminals 61A is shifted more outward in the width direction of the first housing 11 than the inner surface 65a of the first terminals 61B and the inner surface 12c of the protruding parts 12.

In this manner, for each of the terminal rows 60, the outer surfaces 63a and inner surfaces 65a that are the contact surfaces of adjacent first terminals 61 are mutually shifted in the width direction of the first housing 11.

Note that for each of the terminal rows 60, there are inter-terminal walls 12d between adjacent outer column parts 63, inner column parts 65, and connecting parts 64 of adjacent first terminals 61, and these inter-terminal walls 12d are integrated with the outer column parts 63, inner column parts 65, and connecting parts 64. As a result, insulation is reliably maintained between adjacent first terminals 61 while the first terminals 61 are firmly retained in the protruding parts 12 of the first housing 11.

Furthermore, the tail part 62 extending from the lower end of the outer column part 63 of each first terminal 61A protrudes outward in the width direction of the first housing 11 from the side surface of the lower plate part 17a of the bottom plate part 17 at the lower end of the protruding part 12. Conversely, the horizontal part 66 extending from the lower end of the outer column part 63 of each first terminal 61B does not protrude from the side surface of the upper plate part 17b of the bottom plate part 17 at the lower end of the protruding part 12. In other words, the end surface 62a at the tip of the tail part 62 of the first terminal 61A is positioned more to the outside in the width direction of the first housing 11 than the side surface of the bottom plate part 17 while the end surface 66a at the tip of the horizontal part 66 of the first terminal 61B is positioned more to the inside in the width direction of the first housing 11 than the side surface of the bottom plate part 17.

In addition, the lower surface 62b of the tail part 62 of the first terminal 61A is substantially at the same position as the lower surface 17c of the bottom plate part 17, in other words, substantially flush with the lower surface 17c of the bottom plate part 17. Conversely, a lower surface 66b of the horizontal part 66 of the first terminal 61B is positioned higher than the lower surface 62b of the tail part 62 of the first terminal 61A. In other words, the end surface 66a of the horizontal part 66 of the first terminal 61B facing outward in the width direction of the first housing 11 is positioned higher than the lower surface 62b of the tail part 62 of the first terminal 61A. In this manner, the end surface 66a of the first terminal 61B is positioned to the inside of the side surface of the bottom plate part 17 in the width direction of the first housing 11; however, the end surface is positioned higher than the lower surface 62b of the tail part 62 of the first terminal 61A so when the tail part 62 of the first terminal 61A is connected to the connection pad of the first board, solder bridging where solder attaches to the first terminal 61B will not occur.

Note that the lower plate part 17a of the bottom plate part 17 on the outside of the first housing 11 in the width direction includes a tail cover part 17a1 that covers at least a part of the upper surface of the tail part 62 of the first terminal 61A. Thus, the first terminal 61A including the tail part 62 is more firmly retained in the protruding part 12 of the first housing 11. In addition, the lower plate part 17a of the bottom plate part 17 on the inside of the first housing 11 in the width direction also includes a tail cover part 17a1 that covers at least a part of the upper surface of the tail part 62 of the first terminal 61B. Thus, the first terminal 61B including the tail part 62 is more firmly retained in the protruding part 12 of the first housing 11.

Furthermore, a recessed part 17a2 corresponding to the lower plate part 17a of the bottom plate part 17 on the outside of the first housing 11 in the width direction is formed between adjacent tail cover parts 17a1 in a position corresponding to the horizontal parts 66 of the first terminals 61B. This recessed part 17a2 is a recessed part that the connecting arm 68a of the terminal carrier 68 connected to the horizontal part 66 is stowed in. In addition, the upper plate part 17b of the bottom plate part 17 on the outside of the first housing 11 in the width direction includes a horizontal cover part 17b1 that covers at least a part of the upper surface of the horizontal part 66 of the first terminal 61B. Thus, the first terminal 61B including the horizontal part 66 is more firmly retained in the protruding part 12 of the first housing 11.

In the present embodiment, the first terminals 61 are assumed to have a highly conductive metal such as gold, nickel, palladium, or the like that is typically used for connectors plated on the surface thereof to reduce electrical resistance. However, the end surface 62a of the tail part 62 of the first terminal 61A and the end surface 66a at the tip of the horizontal part 66 of the first terminal 61B that are cut surfaces generated by being cut from the connecting arm 68a of the terminal carrier 68 are not plated. Conversely, the end surface 62a of the tail part 62 of the first terminal 61B is not a cut surface generated by being cut from the connecting arm 68a of the terminal carrier 68 and so is plated. In other words, while the end surface 62a of the tail part 62 positioned facing the adjacent second terminal row 60 is plated, the end surface 62a of the tail part 62 not positioned facing the second terminal row 60 is not plated.

With the first connector 10 and second connector 101 in a mated state, the first protruding end part 16 is a portion that functions as an insert protruding part inserted in a mating recessed part 122 of the second protrusion end part 121, described below, provided on the second connector 101 and the first reinforcement fitting 51 is integrally mounted thereto. As described above, both ends of each protruding part 12 are connected to the first protruding end parts 16 via the extension end parts 14 that extend in an inclined direction relative to the longitudinal direction (X-axis direction) of the first connector 10 enabling setting the width (dimension in Y-axis direction) of the first protruding end parts 16 smaller than the width (distance between outer surfaces 12b of left and right protruding parts 12) of the first connector 10. Note that the extension end parts 14 do not necessarily have to be inclined toward the inside and may extend straight.

The first reinforcement fitting 51 is a member integrally formed by punching, bending, or the like of a metal plate, and includes a top plate 54 that extends in the width direction of the first housing 11, and a substantially rectangular leg part 55 connected to both the left and right edges of the top plate 54 and that extends downwardly, is connected to both the front and rear edges of the top plate 54, and includes the end wall outer surface cover part 52 and end wall inner surface cover part 53 that extend downwardly. Note that a tail part 52a is connected to the lower end of the end wall outer surface cover part 52 as a board connecting part. The width of the end wall outer surface cover part 52 is larger than the width of the end wall inner surface cover part 53.

As described above, the first reinforcement fitting 51 is integrated with the first protruding end part 16. Furthermore, the upper plate 54 is embedded in the upper surface of the first protruding end part 16. In this state, the upper surface of the top plate 54 is flush with the upper surface of the first protruding end part 16 and constitutes over half the area of the upper surface of the first protruding end part 16. In addition, the right and left leg parts 55 are embedded in the right and left outer surfaces of the first protruding end part 16. The outer surface of the leg part 55 is flush with the outer surface of the first protruding end part 16 and constitutes over half the area of the outer surface of the first protruding end part 16. Furthermore, the end wall outer surface cover part 52 and the end wall inner surface cover part 53 are embedded in the end wall outer surface and the end wall inner surface of the first protruding end parts 16. The respective outer surfaces of the end wall outer surface cover part 52 and the end wall inner surface cover part 53 are flush with the end wall outer surface and the end wall inner surface of the first protruding end part 16 and constitute over half of the end wall outer surface and over half the area of the end wall inner surface of the first protruding end part 16.

The tail part 52a is connected to the lower end of the end wall outer surface cover part 52 at an angle of approximately 90 degrees, extends outward in the longitudinal direction of the first housing 11 and is connected by soldering or the like to a connection pad connected to a conductive trace of the first board. Furthermore, the conductive trace is typically a power line but also may be a signal line. As required, the lower end of the leg part 55 can be provided close to or in contact with the surface of the first board. In this case, the lower end of the leg part 55 is connected by soldering or the like to a connection pad of the first board, thereby increasing the strength of connection between the first reinforcement fitting 51 and the first board.

A method to produce the first connector 10 configured as above will now be described.

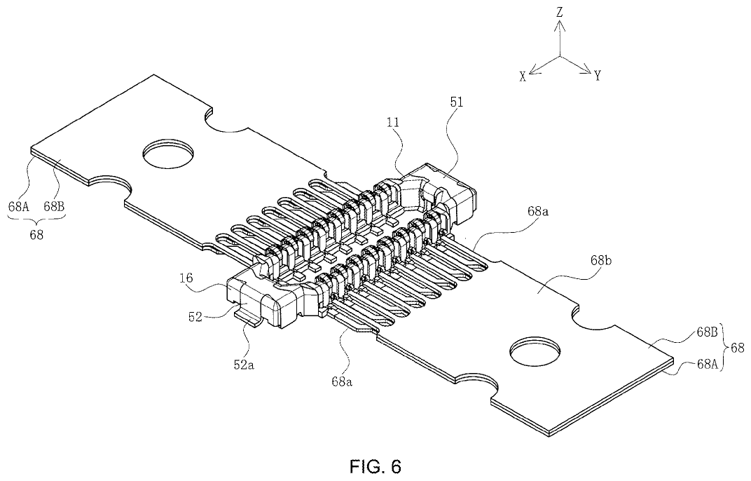

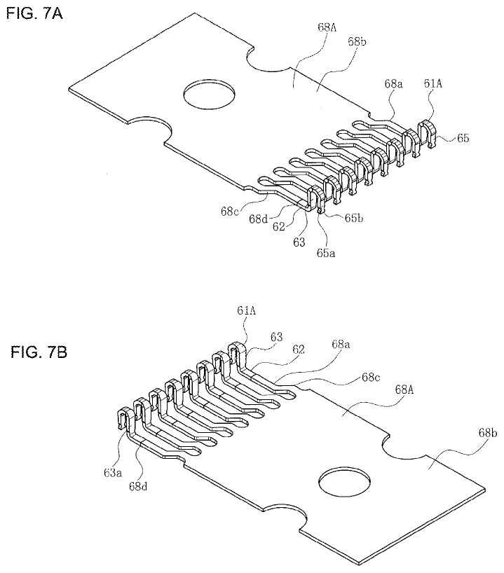

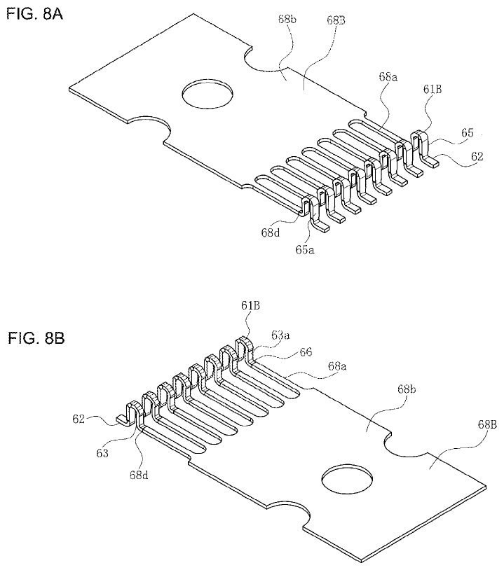

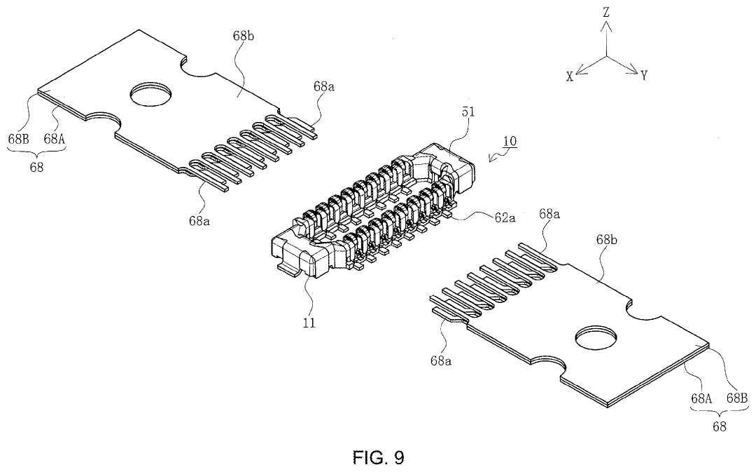

FIG. 6 is a perspective view depicting a first process to produce the first connector according to the present embodiment. FIG. 7 is a perspective view depicting a first carrier connected to the first terminal according to the present embodiment. FIG. 8 is a perspective view depicting a second carrier connected to the first terminal according to the present embodiment. FIG. 9 is a perspective view depicting a second process to produce the first connector according to the present embodiment. Note that in FIGS. 7 and 8, (a) is a diagram depicting the carrier to which the first terminal corresponding to the first terminal row is connected to, and (b) is a diagram depicting the carrier to which the first terminal corresponding to the second terminal row is connected.

The first terminal 61 is a metal plate bent in the plate thickness direction and is made by processing, such as by punching and bending a metal plate. As depicted in FIGS. 6 to 8, a plurality of first terminals 61 are provided connected to a flat board-shaped terminal carrier 68 as a carrier. Furthermore, each of the first terminals 61A that are the first type terminal are connected to the flat shaped carrier body 68b of a first terminal carrier 68A via the long and narrow connecting arm 68a on the tip of the tail part 62, as depicted in FIG. 7, and by being separated from the connecting arm 68a at a cut part 68d, the tail part 62 is the manner of member depicted in FIG. 2. FIG. 7(a) depicts the first terminal carrier 68A and the first terminals 61A corresponding to the terminal row 60 on the upper side (Y-axis negative direction side) in FIG. 3(a). FIG. 7(b) depicts the first terminal carrier 68A and first terminals 61A corresponding to the terminal row 60 on the lower side (Y-axis positive direction side) in FIG. 3(a). In the example depicted in the drawing, with the first terminal carrier 68A, each connecting arm 68a includes a bent part 68c, and thus the tail part 62 connected to the connecting arm 68a is biased away from the carrier body 68b in the positive or negative X-axis direction and in the negative Z-axis direction.

In addition, each of the first terminals 61B that are the second type terminal are connected to the flat shaped carrier body 68b of a second terminal carrier 68B via the long and narrow connecting arm 68a on the tip of the tail part 62, as depicted in FIG. 8, and by being separated from the connecting arm 68a at the cut part 68d, the horizontal part 66 is the manner of member depicted in FIG. 2. FIG. 8(a) depicts the second terminal carrier 68B and first terminals 61B corresponding to the terminal row 60 on the upper side (Y-axis negative direction side) in FIG. 3(a). FIG. 8(b) depicts the second terminal carrier 68B and first terminals 61B corresponding to the terminal row 60 on the lower side (Y-axis positive direction side) in FIG. 3(a). In the example depicted in the figures, with the second terminal carrier 68B, each connecting arm 68a does not include the bent part 68c.

Note that in the example depicted in the figures, with the first terminal carrier 68A, the bent part 68c is formed on the connecting arm 68a and the tail part 62 is biased away from the carrier body 68b, while with the second terminal carrier 68B, the bent part 68c is not formed on the connecting arm 68a; however, it is not limited to this, where, with the second terminal carrier 68B, the bent part 68c may be formed on the connecting arm 68a and the tail part 62 biased away from the carrier body 68b, while with the first terminal carrier 68A, not forming the bent part 68c on the connecting arm 68a is feasible. Furthermore, if there is bias in the relative positions of the connecting arm 68a of the first terminal carrier 68A and the connecting arm 68a of the second terminal carrier 68B, not forming the bent part 68c on the connecting arm 68a for both the first terminal carrier 68A and the second terminal carrier 68B is feasible. However, if the bent part 68c is not formed on the connecting arm 68a, maintaining positional accuracy of the first terminal 61 in conjunction with size reduction of the first connector 10 becomes difficult so forming the bent part 68c on the connecting arm 68a of one of the first terminal carrier 68A or second terminal carrier 68B to provide bias to the relative position of the connecting arm 68a is desirable.

Furthermore, in the step of integrally molding with the first housing 11 using insert molding, the first terminals 61 are in a state of being supplied connected to the plurality of terminal carriers 68 and set in a mold for molding (not depicted), as depicted in FIG. 6. Specifically, the second terminal carrier 68B as depicted in FIG. 8(a) is overlapped on the first terminal carrier 68A as depicted in FIG. 7(a); and thus set in the mold for molding, positioned with the first terminals 61A and first terminals 61B arranged alternately; and thereby constituting the terminal row 60 on the Y-axis negative direction side. In a similar manner, the second terminal carrier 68B as depicted in FIG. 8(b) is overlapped on the first terminal carrier 68A as depicted in FIG. 7(b); and thus set in the mold for molding, positioned with the first terminals 61A and first terminals 61B arranged alternately; and thereby constituting the terminal row 60 on the Y-axis positive direction side.

Furthermore, as depicted in FIG. 6, a pair of first reinforcement fittings 51 are also provided. Note that similar to the first terminals 61, each of the first reinforcement fittings 51 are members made from a metal plate bent in the thickness direction, produced by performing punching, bending, and the like processes on a metal plate and provided in a state of being connected to a carrier but for convenience of explanation, depiction of the first reinforcement fitting 51 carrier is omitted. Thus, the pair of first reinforcement fittings 51 are positioned in a position at both ends of the first connector 10 in the longitudinal direction and set in a mold for molding.

Subsequently, melted insulating material, such as synthetic resin, is injected into the cavity of the mold for molding. In other words, insert molding is performed. Note that the insulating material may be any type of material but here, with importance placed on flowability, use of liquid crystal polymer (LCP) is desirable. When the injected insulating material is cooled and solidified so as to form the first housing 11, the mold for molding is opened and the blank of the first connector 10 in a state of the first terminals 61 connected to the terminal carriers 68, as depicted in FIG. 6 is removed therefrom.

Subsequently, the terminal carrier 68 is cut from the blank of the first connector 10 depicted in FIG. 6. Specifically, at the cut part 68d depicted in FIG. 7, the connecting arm 68a of the first terminal carrier 68A is cut; thereby the tail part 62 of the first terminal 61A is separated from the connecting arm 68a and at the cut part 68d depicted in FIG. 8, the connecting arm 68a of the second terminal carrier 68B is cut; and thereby the horizontal part 66 of the first terminal 61B is separated from the connecting arm 68a. In addition, a carrier (not depicted) is also separated from each of the first reinforcement fittings 51. As a result, as depicted in FIG. 9, the terminal carrier 68 and carriers for the first reinforcement fittings 51 are removed to obtain the completed product first connector 10.

Next, the configuration of the second connector 101 that constitutes a connector pair together with this first connector 10 will be described.

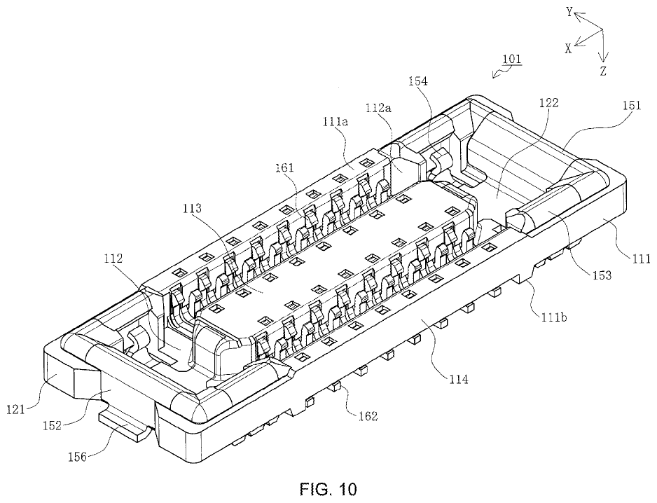

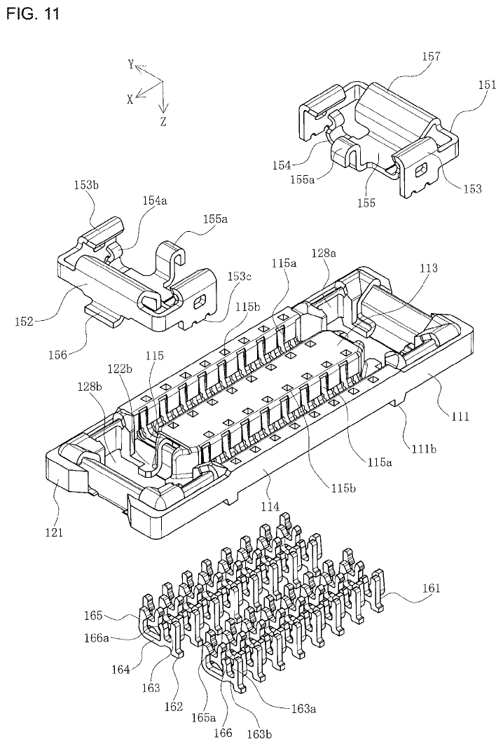

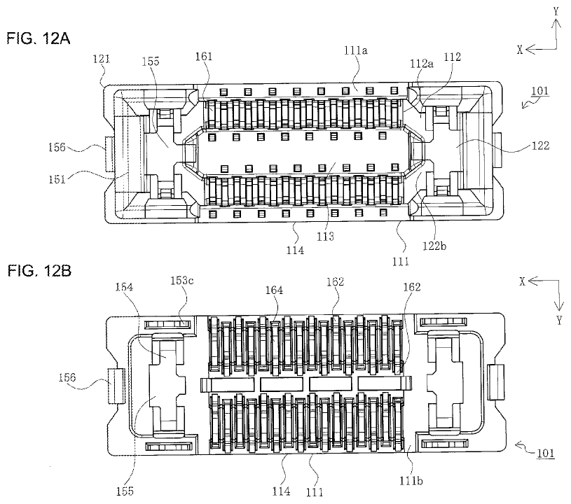

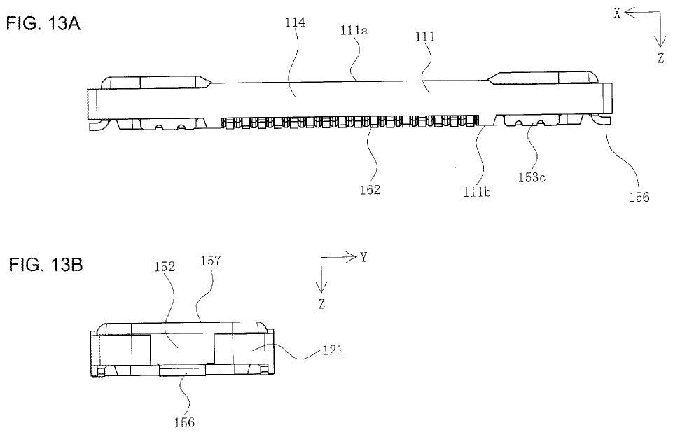

FIG. 10 is a perspective view of the second connector according to the present embodiment. FIG. 11 is an exploded view of the second connector according to the present embodiment. FIG. 12 is a first two-plane view of the second connector according to the present embodiment. FIG. 13 is a second two-plane view of the second connector according to the present embodiment. Note that in FIG. 12, (a) is a top view, and (b) is a bottom view, and in FIG. 13, (a) is a side view, and (b) is a front view.

The second connector 101, as a counterpart connector according to the present embodiment, has a second housing 111 as a counterpart connector main body integrally formed of an insulating material such as synthetic resin. As depicted in the figure, the second housing 111 has a substantially rectangular thick plate-like shape that is a substantially rectangular parallelepiped. Furthermore, the side of the second housing 111 into which the first connector 10 is inserted, in other words, the side of the mating surface 111a (Z-axis negative direction side), is a substantially rectangular recessed part 112 with an enclosing periphery, forming the recessed part 112 to be mated with the first housing 11. Inside the recessed part 112 is the second protruding part 113, as an insular part to be mated with a recessed groove part 13, that is integrally formed with the second housing 111; moreover, side wall parts 114 extending in parallel with the second protruding part 113 on both sides of the second protruding part 113 are integrally formed with the second housing 111.

The second protruding part 113 and the side wall parts 114 protrude upwardly (Z-axis negative direction) from the bottom surface of the recessed part 112 and extend in the longitudinal direction of the second connector 101. Consequently, a recessed groove part 112a that is an elongated recessed part extending in the longitudinal direction (X-axis direction) of the second connector 101 is formed as part of the recessed part 112 on both the sides of the second protruding part 113.

A second terminal stowing groove cavity 115a in the shape of a recessed groove is formed on the side surfaces of both sides of the second protruding part 113 and the side surfaces of the inside of the side wall parts 114. In addition, a second terminal stowing hole-shape cavity 115b in the shape of a hole is formed on the second protruding part 113 and the side wall parts 114. The second terminal stowing groove cavity 115a and the second terminal stowing hole-shape cavity 115b are connected and integrated with each other on the bottom surface of the recessed groove part 112a. The second terminal stowing groove-shape cavity 115a and the second terminal stowing hole-shape cavity 115b are therefore described as a second terminal stowing cavity 115 when collectively described. The second terminal stowing cavity 115 is disposed at a pitch corresponding to the first terminals 61 and at the corresponding appropriate number. Furthermore, each second terminal stowing cavity 115 stows the second terminals 161 as counterpart terminals; thereby, the plurality of second terminals 161 are arranged lined up in each recessed groove part 112a at a pitch and quantity corresponding to the first terminals 61 (16 pieces in the example depicted in the figures).

The second terminals 161 are members integrally formed by performing punching and the like processing on a conductive metal plate, and include: a main body part 163 extending in the vertical direction (Z-axis direction), a tail part 162 connected to the lower end (Z-axis positive direction end) of the main body part 163, a proximal connecting part 163b extending in the width direction (Y-axis direction) of the second connector 101 from close to the bottom end of the main body part 163, a proximal contacting part 166 as a first contact part connected near the lower end of the tip of the proximal connecting part 163b and extending in the vertical direction, a distal connecting part 164 extending from the lower end of the proximal contacting part 166 in the width direction of the second connector 101, and a distal contacting part 165 extending upward (Z-axis negative direction) from the tip of the distal connecting part 164.

Note that a proximal contact protruding part 166a and a distal contact protruding part 165a are desirably formed facing each other near the tips of the proximal contacting part 166 and the distal contacting part 165. Furthermore, the main body part 163 is a portion press fit and retained in the second terminal stowing hole-shape cavity 115b and an engaging protruding part 163a for penetrating into the side surface of the second terminal stowing hole-shape cavity 115b is desirably formed near the tip thereof.

In addition, the tail part 162 is bent and connected to the lower end of the main body part 163, extends in the width direction of the second housing 111, and is connected by soldering or the like to a connection pad that is connected with the conductive trace of the second substrate. Note that the conductive trace is typically a signal line but also may be a power line. Furthermore, the proximal contacting part 166 and the distal contacting part 165 are portions that contact the first terminals 61 provided in the first connector 10 when the first connector 10 and the second connector 101 are mated. The proximal contact protruding part 166a and the distal contact protruding part 165a contact the inner surface 65a and outer surface 63a that are the contact surfaces of the first terminal 61, and desirably engage with the upper end protruding part 64a.

The second terminal 161 is inserted into the second terminal stowing cavity 115 from the lower part of the second housing 111 and mounted in the second housing 111. Therefore, the main body part 163 is press fit and retained in the second terminal stowing hole-shape cavity 115b and the proximal contacting part 166 and distal contacting part 165 are exposed in the recessed groove part 112a and the lower surface of the tail part 162 of the second terminal 161 is exposed to a mounting surface 111b as the lower surface of the second housing 111.

In addition, the second terminals 161 mounted in each recessed groove part 112a constitute a terminal row extending in the longitudinal direction of the second connector 101 along each recessed groove part 112a, and in each of the terminal rows, adjacent second terminals 161 are aligned in an orientation where they face each other in the width direction of the recessed groove part 112a. In the example depicted in FIGS. 10 to 13, of the second terminals 161 mounted in the recessed groove part 112a on the side in the Y-axis positive direction side, the second terminal 161 positioned at the front end (end in the X-axis positive direction) is oriented such that the tail part 162 protrudes in the Y-axis negative direction, while the second terminal 161 positioned second from the front end is oriented such that the tail part 162 protrudes in the Y-axis positive direction. In this manner, as the second terminals 161 are mounted in the recessed groove part 112a arranged in a line in alternating directions, the pitch of the tail parts 162 exposed on the mounting surface 111b on both sides of the recessed groove part 112a is set to twice the pitch of the second terminals 161. Therefore, connection work by soldering or the like to the connection pad of the second substrate can easily be performed. In addition, the pitch of the proximal contacting part 166 and the distal contacting part 165 exposed to the recessed groove part 112a is two times the pitch of the second terminals 161.

In addition, the orientation of second terminals 161 mounted to each recessed groove part 112a adjacent in the width direction to the second connector 101 are set so as to face opposite directions. In the example depicted in FIGS. 10 to 13, in both terminal rows on the Y-axis positive direction side and the Y-axis negative direction side, the orientation of the second terminal 161 positioned on the front end (X-axis positive direction end) is aligned such that the tail part 162 protrudes in the Y-axis negative direction, and the orientation of the second terminal 161 positioned second from the front end is aligned such that the tail part 62 protrudes in the Y-axis positive direction.

In addition, the second protrusion end parts 121 are disposed as mating guide parts on both ends in the longitudinal direction of the second housing 111. The mating recessed parts 122 are formed as part of the recessed part 112 in each second protrusion end part 121. The mating recessed parts 122 are substantially rectangular recess parts that are connected to both ends in the longitudinal direction of each recessed groove part 112a. Furthermore, in a state in which the first connector 10 and the second connector 101 are mated inside the mating recessed part 122, the first protruding end part 16 provided on the first connector 10 is inserted.

A second reinforcement fitting 151 as a counterpart reinforcement fitting is attached to the second protrusion end part 121. Note that this second reinforcement fitting 151 is a member integrated with the second housing 111 during insert molding and so is not present separated from the second housing 111. Also, the location that the second reinforcement fitting 151 is attached to the second housing 111 is not present in the form depicted in FIG. 11, in a state of being separated from the second reinforcement fitting 151. It should be understood that the depiction in FIG. 11 is simply for convenience of description.

The second reinforcement fitting 151 is a member integrally formed by performing punching, bending, and the like processes on a metal plate, and includes: a second main body part 152 extending in the width direction of the second housing 111, a lateral covering part 153 connected at both left and right ends of the second main body part 152, a pair of left and right tail parts 156 connected to the lower end of the second main body part 152, an end wall cover part 157 connected to an upper end of the second main body part 152, a recessed part cover part 155 connected to the end wall cover part 157, and a contact arm part 154 as a pair of left and right elastic members. The tail part 156 extends facing outwards in the longitudinal direction of the second connector 101 and is connected and secured to a connection pad (not depicted) by soldering or the like connected to a conductive trace on the second board. Note that the conductive trace is typically a power line but also may be a signal line. In addition, a lower end 153c of the lateral covering part 153 may get close to or come into contact with the surface of the second board, as necessary. In this case, the lower end 153c of the lateral covering part 153 is connected by soldering or the like to a connection pad of the second board, thereby increasing the strength of connection between the second reinforcement fitting 151 and the second board.

Upper ends of each of the lateral covering parts 153 are connected by a side wall upper cover part 153b. This side wall upper cover part 153b is bent more than 90 degrees and the tip thereof extends obliquely downward facing the inside of the mating recessed part 122. In addition, a contact protrusion part 154a is formed near an upper end, in other words, a tip of the contact arm part 154 as a contact part is formed in a shape so as to swell towards the center in the width direction of the second housing 111. Furthermore, an island end cover part 155a is connected to the tip of the recessed part cover part 155, centered in the width direction of the second connector 101.

Furthermore, the recessed part cover part 155 is stowed in a bottom plate opening 128b formed penetrating a bottom plate 122b of the mating recessed part 122 in the plate thickness direction (Z-axis direction). In addition, the contact arm part 154 is stowed in the bottom plate opening 128b and a side wall recess part 128a formed on the inside surface of the mating recessed part 122 continuous with the bottom plate opening 128b. Note that the contact arm part 154 is not integrated with the second housing 111 and is stowed in an elastically deformable state in the bottom plate opening 128b and the side wall recess part 128a. Therefore, the contact arm part 154 that functions as an elastic member has a long spring length and so can exhibit a spring force, applying contact pressure on the contact protrusion part 154a for securely retaining the contact protrusion part 154a on the first reinforcement fitting 51.

In addition, the island end cover part 155a covers both ends of the second protruding part 113, in other words, the island ends, with at least the tip thereof embedded. Therefore, both ends in the longitudinal direction of the second protruding part 113 will not break when the first connector 10 and the second connector 101 are mated even if a part comes into contact with the first connector 10.

Next, the operation of mating together the first connector 10 and the second connector 101 with the above configuration will be described.

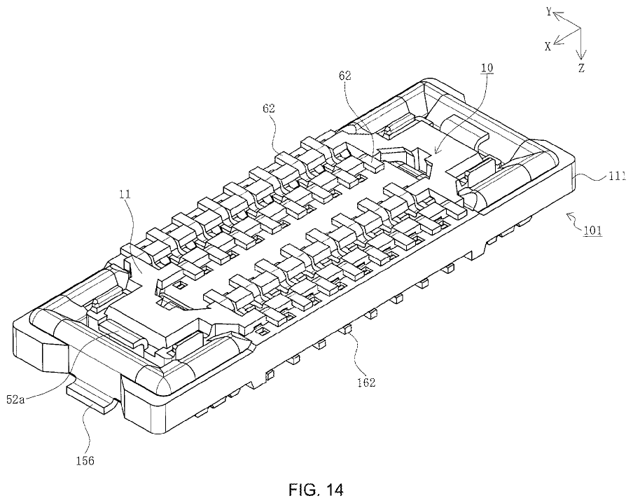

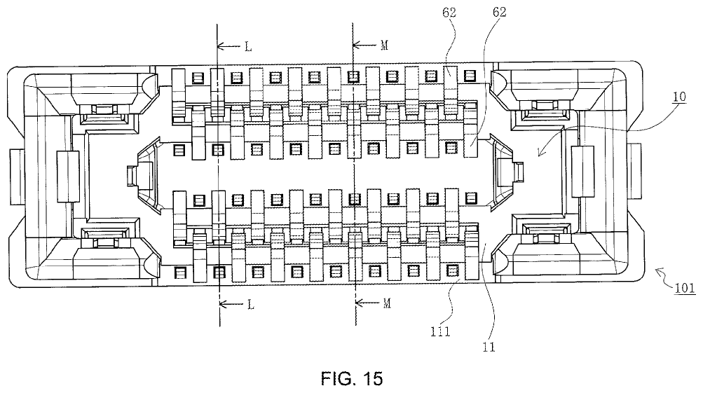

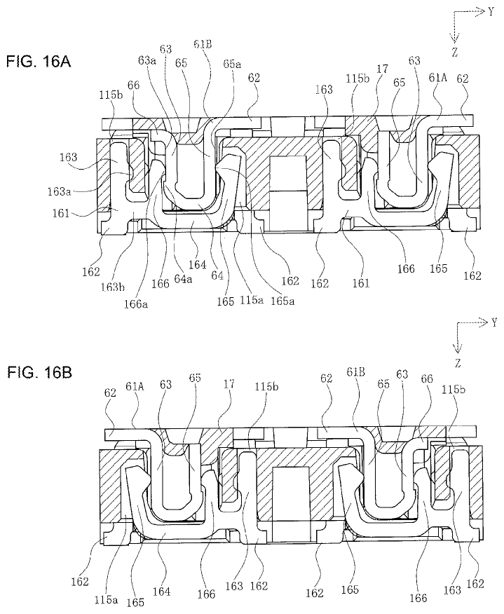

FIG. 14 is a perspective view viewed from the first connector side depicting the state of the first connector and the second connector mated according to the present embodiment. FIG. 15 is a plan view viewed from the first connector side depicting the state of the first connector and the second connector in a mated state according to the present embodiment. FIG. 16 is a cross section view depicting a state in which the first connector and second connector according to Embodiment 2 are mated. Note that in FIG. 16, (a) is a cross section view taken along the line L-L in FIG. 15, and (b) is a cross section view taken along the line M-M in FIG. 15.

The first connector 10 is mounted on the surface of the first board with the tail parts 62 of the first terminals 61 connected by soldering or the like to a connection pad (not depicted) connected with a conductive trace of the first board, and with the tail part 52a of the first reinforcement fitting 51 connected by soldering or the like to a connection pad connected with a conductive trace of the first board. Note that the conductive trace connected to the connection pad to which the tail part 62 of the first terminal 61 is connected is a signal line, while the conductive trace connected to the connection pad to which the tail part 52a of the first reinforcement fitting 51 is connected is a power line.

Similarly, the second connector 101 is mounted on the surface of the second board with the tail parts 162 of the second terminals 161 connected by soldering or the like to a connection pad (not depicted) connected with a conductive trace of the second board, and with the tail part 156 of the second reinforcement fitting 151 connected by soldering or the like to a connection pad connected with a conductive trace of the second board. Note that the conductive trace connected to the connection pad to which the tail part 162 of the second terminal 161 is connected is a signal line, while the conductive trace connected to the connection pad to which the tail part 156 of the second reinforcement fitting 151 is connected is a power line.

First, an operator opposes the mating surface 12a of the protruding part 12 as the mating surface of the first housing 11 of the first connector 10 and the mating surface 111a of the second housing 111 of the second connector 101, such that when the position of the protruding part 12 of the first connector 10 is aligned with the position of the corresponding recessed groove part 112a of the second connector 101 and when the position of the first protruding end part 16 of the first connector 10 aligns with the position of the corresponding mating recessed part 122 of the second connector 101, position alignment of the first connector 10 and the second connector 101 is complete.

In this state, if the first connector 10 and/or the second connector 101 moves in the direction approaching the counterpart side, or in other words, the mating direction, the protruding part 12 and first protruding end part 16 of the first connector 10 are inserted into the recessed groove part 112a and mating recessed part 122 of the second connector 101. Therefore, as depicted in FIGS. 14 to 16, mating of the first connector 10 and the second connector 101 is complete.

Furthermore, the first terminals 61 and the second terminals 161 are placed in a conductive state. Specifically, as depicted in FIG. 16, the outer column part 63, connecting part 64, and inner column part 65 of the first terminal 61 enter in between the corresponding proximal contacting part 166 and the distal contacting part 165 of each of the second terminals 161. Furthermore, the proximal contact protruding part 166a of the proximal contacting part 166 and the distal contact protruding part 165a of the distal contacting part 165 come into contact with the outer surface 63a of the outer column part 63 and inner surface 65a of the inner column part 65 that are contact surfaces.

Here, the distance from the outer surface 63a to the inner surface 65a for each first terminal 61 is larger than the distance from the proximal contact protruding part 166a to the distal contact protruding part 165a for the second terminal 161 so that when the outer column part 63, connecting part 64, and inner column part 65 of the first terminal 61 enter in between the corresponding proximal contacting part 166 and distal contacting part 165 of each second terminal 161, the second terminal 161 is elastically deformed, and the spacing between the proximal contact protruding part 166a and the distal contact protruding part 165a increases. Therefore, by means of the repulsive force of the second terminal 161, the proximal contact protruding part 166a and the distal contact protruding part 165a are in a state of being pressed against the outer surface 63a and the inner surface 65a, reliably maintaining the contact between the proximal contact protruding part 166a and distal contact protruding part 165a and outer surface 63a and inner surface 65a. Thus, the conducting state between the first terminal 61 and the second terminal 161 is reliably maintained.

In this manner, with the present embodiment, the first connector 10 is provided with the first housing 11 and the plurality of first terminals 61 attached in the first housing 11. Furthermore, the plurality of first terminals 61 form the terminal row 60 extending in the longitudinal direction of the first connector 10 and one first terminal 61A of a pair of adjacent first terminals 61 includes an end surface 62a facing outward in the width direction of the first connector 10 and a lower surface 62b adjacent to the end surface 62a that is a lower surface 62b soldered to the board, and another first terminal 61B of the adjacent pair of first terminals 61 has the end surface 66a facing outward in the width direction of the first connector 10, which is the end surface 66a at a position higher than the lower surface 62b of the first terminal 61A.

Thus, the pitch of the first terminals 61 in the terminal row 60 is narrow enabling narrowing the spacing of the terminal row 60 so solder bridging does not occur, manufacturing is simple, size reduction is feasible even when there are multiple poles, and reliability of the first connector 10 is improved.

In addition, the first terminal 61 has a tail part 62, there are a plurality of terminal rows 60, and of the end surfaces 62a of the tail parts 62, opposing end surfaces 62a of adjacent terminal rows 60 are plated, and non-opposing end surfaces 62a of adjacent terminal rows 60 are not plated. Furthermore, the first terminal 61 is integrally retained in the first housing 11 and the plurality of terminal rows 60 are integrally connected.

Furthermore, the positions of outer surfaces 63a of adjacent first terminals 61 in the terminal row 60 are mutually shifted in the width direction of the first connector 10. Furthermore, the first terminal 61 includes an outer surface 63a and an inner surface 65a that are contact surfaces and the positions of the two contact surfaces of adjacent first terminals 61 in the terminal row 60 are mutually shifted in the width direction of the first connector 10. Furthermore, of the two contact surfaces, the width dimension of the contact surface on the proximal side of the tail part 62 is larger than that of the contact surface on the distal side of the tail part 62.

In addition, in the present embodiment, the method for manufacturing the first connector 10 is a method for manufacturing the first connector 10 providing the first housing 11 and the plurality of first terminals 61 attached to the first housing 11, and the plurality of first terminals 61 form the terminal row 60 extending in the longitudinal direction of the first connector 10. Furthermore, a step of integrally molding first terminals 61 that are adjacent in a terminal row 60 and are connected by overlapping and mutually different terminal carriers 68 to the first housing 11, which is a step of connecting the tail part 62 of the first terminal 61A that is one of the adjacent first terminals 61 to the first terminal carrier 68A that is one of the mutually different terminal carriers 68, connecting the horizontal part 66 that is the non-tail part of the first terminal 61B that is the other of the adjacent first terminals 61 to the second terminal carrier 68B that is the other of the mutually different terminal carriers 68, overlapping the first terminal carrier 68A below the second terminal carrier 68B; and integrally molding with the first housing 11; and a step of separating the first terminals 61 integrally molded with the first housing 11 from the terminal carriers 68; may be included.

Thereby, the first connector 10 can be easily manufactured.

Note that the disclosure herein describes features relating to suitable exemplary embodiments. Various other embodiments, modifications, and variations within the scope and spirit of the claims appended hereto will naturally be conceived of by those skilled in the art upon review of the disclosure herein.

The present disclosure can be applied to connectors, connector pairs, and manufacturing methods thereof.

1. A connector, comprising:
a connector main body, and a plurality of terminals attached to the connector main body;
wherein the plurality of terminals form a terminal row extending in the longitudinal direction of the connector;
a first terminal of a pair of adjacent terminals has an end surface facing outward in the width direction of the connector and a lower surface adjacent to the end surface, the lower surface for soldering to a board; and
a second terminal of the pair of adjacent terminals has an end surface facing outward in the width direction of the connector, the end surface being positioned higher than the lower surface of the first terminal.

2. The connector according to claim 1, wherein the terminals have a board connecting part, there are a plurality of terminal rows, and of the end surfaces of the board connecting parts, end surfaces that face an adjacent terminal row are plated and end surfaces that do not face the adjacent terminal row are not plated.

3. The connector according to claim 2, wherein the terminals are integrally retained in the connector main body and the plurality of terminal rows are integrally linked.

4. The connector according to claim 1, wherein the outer surface positions of adjacent terminals in the terminal row are mutually shifted in the width direction of the connector.

5. The connector according to claim 1, wherein the terminals have two contact surfaces and the positions of the contact surfaces of two adjacent terminals in the terminal row are mutually shifted in the width direction of the connector.

6. The connector according to claim 5, wherein the terminals have a board connecting part and of the two contact surfaces, the width dimension of the contact surface on the proximal side of the board connecting part is larger than that of the contact surface on the distal side of the board connecting part.

7. A connector pair, comprising the connector according to claim 1 and a counterpart connector that mates with the connector.

8. A method of manufacturing having a connector main body provided with a plurality of terminals attached to the connector main body, the connectors forming a terminal row extending in the longitudinal direction of the connector, comprising:
a step of integrally molding terminals that are adjacent in a terminal row, are connected by overlapping and which are mutually different carriers;
a step of integrally molding with the connector main body: a first of the adjacent terminals having a board connecting part connected to a first of the mutually different carriers, and a second of the adjacent terminals having a non-board connecting part connected to a second of the mutually different carriers and the first carrier overlaps below the second carrier; and
a step of separating the terminals integrally molded with the connector main body from the carrier.
